(19) United States
(12) Patent Application Publication
(10) Pub. No.: US 2018/0247352 A1
(43) Pub. Date: Aug. 30, 2018

(54) CHATBOT ORDER SUBMISSION

(71) Applicant: NCR Corporation, Duluth, GA (US)

(72) Inventors: April Irene Rogers, Atlanta, GA (US); Samarth Agarwal, Duluth, GA (US); Matthew Grogan, Duluth, GA (US); Yongching Tee, Atlanta, GA (US)

(21) Appl. No.: 15/444,283

(22) Filed: Feb. 27, 2017

(51) Int. Cl. G06Q 30/06; H04L 12/58; G06Q 50/12

(52) U.S. Cl. CPC G06Q 30/0601; G06Q 50/12; H04L 51/02

(57) ABSTRACT

Various embodiments each include at least one of systems, devices, methods, and software for chatbot order submission by group members for products to an entity that will provide the ordered products. The group may be just a single person or may be many people. One example embodiment that may be performed by a chatbot or an element of a chat host platform includes identifying an activity command received over a network from a participant within a text-based chat session. This method further includes executing a data processing activity associated with the identified activity command, the executing of the activity including generating and transmitting task data over the network to a data processing system of an entity that will perform a task based on the task data.

### BACKGROUND INFORMATION

Ordering products for a group, such as lunch or beverage orders for a meeting, can be a time consuming and clumsy process. Often times each group member will email a coordinating group member that will then put all the orders together and submit one single order. This is time-consuming for the coordinating group member and often confusing. Collecting payment, handling product pickup or delivery, and the like is also often challenging as payments add another layer of complexity and different arrival times and order fulfillment present further challenges.

### SUMMARY

Various embodiments each include at least one of systems, devices, methods, and software for chatbot order submission by group members for products to an entity that will provide the ordered products. The group may be just a single person or may be many people.

One example embodiment that may be performed by a chatbot or an element of a chat host platform includes identifying an activity command received over a network from a participant within a text-based chat session. This method further includes executing a data processing activity associated with the identified activity command, the executing of the activity including generating and transmitting task data over the network to a data processing system of an entity that will perform a task based on the task data.

Another method embodiment includes identifying activity command, received over a network from a plurality of participants within a text-based chat session. This method further includes executing data processing activities associated with the identified activity commands, the executing of the activities including generating and transmitting task data over the network to a data processing system of an entity that will perform tasks based on the task data.

A further embodiment, in the form of a system, includes a network interface device, a computer processor, and a memory device storing instructions that are executable by the computer processor to perform data processing activities. The data processing activities may include identifying an activity command received via the network interface device from a participant within a text-based chat session. The data processing activities may further include executing a data processing activity associated with the identified activity command, the executing of the activity including generating and transmitting task data via the network interface device to a data processing system of an entity that will perform a task based on the task data.

### BRIEF DESCRIPTION OF THE DRAWINGS

FIG. 1 includes logical block and logical system architecture diagrams, according to example embodiments.

FIG. 2 is a block flow diagram of a method, according to an example embodiment.

FIG. 3 is a block diagram of a computing device, according to an example embodiment.

### DETAILED DESCRIPTION

Various embodiments each include at least one of systems, devices, methods, and software for chatbot order submission by group members for products to an entity that will provide the ordered products. The group may be just a single person or may be many people. A common scenario where the present embodiments maybe employed is with regard to a food or beverage order at restaurant, coffee shop, or bar for pickup or delivery as part of a meeting. Another scenario is a communal grocery list or order from a family or roommates where a grocery order is submitted for pickup or delivery. Other scenarios will certainly be readily apparent, which may include scenarios where a single person is placing an order.

Regardless of the particular scenario of an embodiment, all scenarios have some commonality in that an order may be placed by one or more text-based chat participants and another automated participant, referred to as a chatbot. The chatbot identifies ordered products in a stream of text-based chat messages, builds the order, and submits the order when ready for processing, preparation, and delivery, either via pickup by an individual or delivery by an entity to whom the order is placed. The text-based chat session is conducted via a text-based chat tool, which may operate in a peer-to-peer manner or in a hub-and-spoke arrangement where a server process operates to receive text-based messages from participants and distributes them to other participants.

In peer-to-peer embodiments, the chatbot may be a process that executes on a network accessible server and may be invited by a participant to join a peer-to-peer text-based chat session. The chatbot is then a virtual participant. In other embodiments, the chatbot may be a part of or a plugin or add-on of or to a client app or application, and the like. In hub-and-spoke embodiments, the chatbot may also be invited to join, may always be listening to all chat sessions, be a part or a plugin or add-on to a client app or application, and the like.

The chatbot may be custom developed or built upon an existing chatbot framework, such as the BOT FRAMEWORK available from. MICROSOFT® Corporation of Redmond, Wash. The chatbot is tailored in some embodiments to certain words that may be used as commands or triggers for certain functionality, such as adding an item to an order, retrieving a list of items already added to an order, closing an order, canceling an order, submitting an order, and the like. Further, some embodiments may include payment functionality, which may be built into the chat tool, leverage existing payment functionality within a device on which a participant is chatting (e.g., payment functionality that is integrated into a mobile device, smartwatch, tablet, etc.), or otherwise integrated with other mobile and online payment solutions. The payment solution may be performed in-band (within the text-based chat) or out-of-band, meaning invoking payment through another means, such as by the chatbot providing a link to another an online payment portal, a link that invokes a device-based payment solution, and the like.

These and other embodiments are described herein with reference to the figures.

In the following detailed description, reference is made to the accompanying drawings that form a part hereof, and in which is shown by way of illustration specific embodiments in which the inventive subject matter may be practiced. These embodiments are described in sufficient detail to enable those skilled in the art to practice them, and it is to be understood that other embodiments may be utilized and that structural, logical, and electrical changes may be made without departing from the scope of the inventive subject matter. Such embodiments of the inventive subject matter may be referred to, individually and/or collectively, herein by the term “invention” merely for convenience and without intending to voluntarily limit the scope of this application to any single invention or inventive concept if more than one is in fact disclosed.

The following description is, therefore, not to be taken in a limited sense, and the scope of the inventive subject matter is defined by the appended claims.

The functions or algorithms described herein are implemented in hardware, software or a combination of software and hardware in one embodiment. The software comprises computer executable instructions stored on computer-readable media such as memory or other type of storage devices. Further, described functions may correspond to modules, which may be software, hardware, firmware, or any combination thereof. Multiple functions are performed in one or more modules as desired, and the embodiments described are merely examples. The software is executed on a digital signal processor, ASIC, microprocessor, or other type of processor operating on a system, such as a personal computer, server, a router, or other device capable of processing data including network interconnection devices.

Some embodiments implement the functions in two or more specific interconnected hardware modules or devices with related control and data signals communicated between and through the modules, or as portions of an application-specific integrated circuit. Thus, the exemplary process flow is applicable to software, firmware, and hardware implementations.

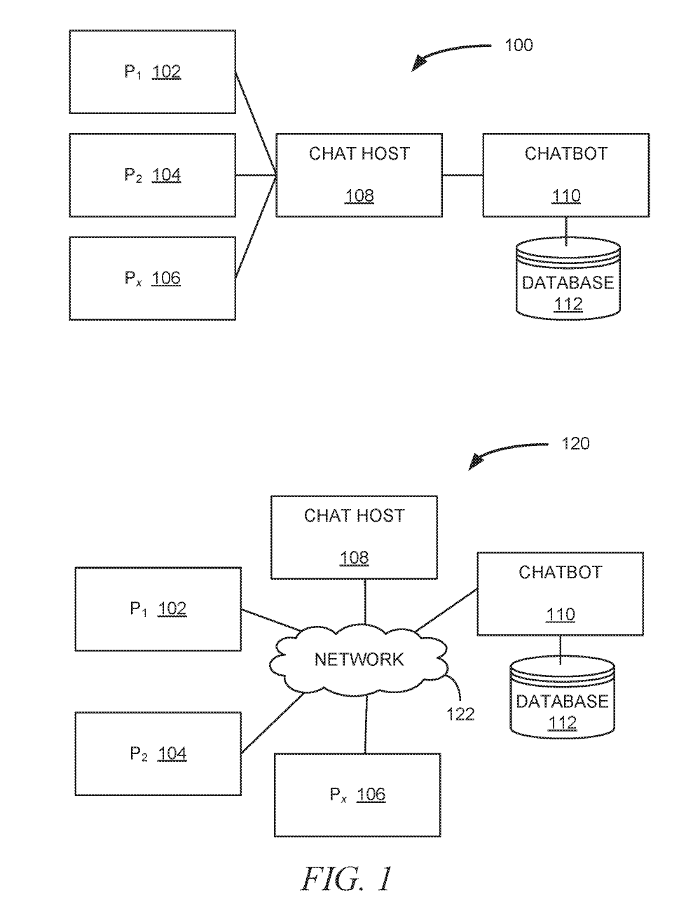

FIG. 1 includes logical block and logical system architecture diagrams, 100 and 120 respectively, according to example embodiments. The logical block diagram 100 includes a number of participants P₁, P₂2, . . . Pₓ, 102, 104, 106. The participants 102, 104, 106 are each connected to a chat host 108. The chat host 108 is also connected to a chatbot 110, which is a virtual participant in a text-based chat session with the participants 102, 104, 106. The chatbot 110 may also be connected to a database 112. The database 112 may be an actual database but may instead be one or a set of flat files. Regardless, the database 112 represents a stored set of configuration settings that instruct the chatbot 110 how to operate. This may include keywords to listen for in a chat session, a store, restaurant, or other entity to notify of an order, a menu of available products including pricing, and the like.

Thus, in00, operation, one of the participants may initiate an order using a keyword, keyword combination, or text indicating an intent to initiate an order that is identifiable by artificial intelligence functionality of the chatbot 110. The order initiating text-based message may include or be followed with one or more initial messages indicating where or when the order is to be picked up or delivered, provide payment details, and the like. Each participant may then text message their order items to the chat host 108 and the chatbot 110 will receive the messages and gather the group order. Eventually, the order will be complete and one of the participants 102, 104, 106 will send a close order or submit order command or intent that is understood by the artificial intelligence functionality that may be present in the chatbot 110 in some embodiments. The order may then be transmitted by the chatbot 110 to the particular store, restaurant, or other entity relevant to the particular order. The chatbot 110 may then receive a confirmation, a delivery or pickup time, a total amount due, and other information depending on the particular embodiment, order type, and the like. This data may then be transmitted back to one or more of the chat participants 102, 104, 106 via the chat host 108. The order may then be complete.

Continuing with FIG. 1, the logical system architecture diagram 120 includes the same elements as the logical block diagram 100, but adds a network 122 that interconnects the various elements thereof. Note that in some embodiments, the chatbot 110 may be integrated within the chat host 108 or within a chat application or app of one or more of the participants 102, 104, 106. Note as well, that the chat host 108 may not be present in all embodiments as some embodiments may operate in a peer-to-peer manner rather than the hub-and-spoke manner as illustrated.

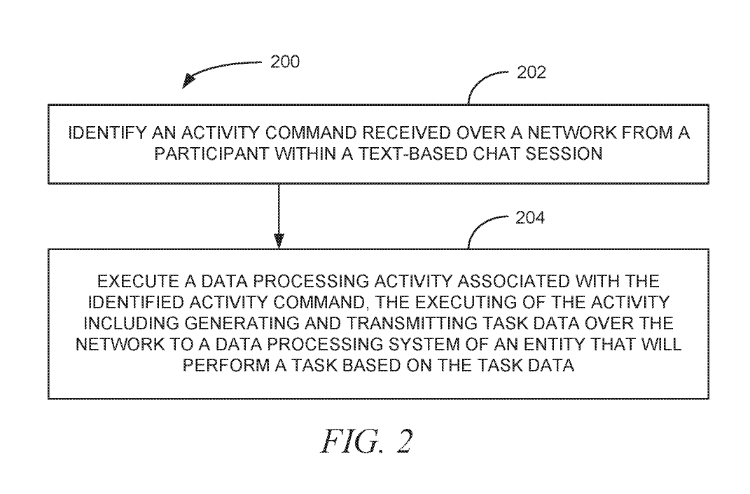

FIG. 2 is a block flow diagram of a method 200, according to an example embodiment. The method 200 is an example of a method that may be performed by a chatbot, such as chatbot 110 of FIG. 1.

The method 200 includes identifying 202 an activity command received over a network from a participant within a text-based chat session. The activity command may be an express command known to a chatbot performing the method 200 or an intent identified in one or more text-based messages from the participant by an artificial intelligence engine that processes the received text-based messages in some embodiments.

The method 200 further includes executing 204 a data processing activity associated with the identified 202 activity command. The executing 204 of the activity may include generating and transmitting task data over the network to a data processing system of an entity that will perform a task based on the task data. The entity may be a restaurant that will prepare an order, a grocery store that will gather ordered items for pickup or delivery to the participants, and the like.

In some embodiments of the method 200, the activity command is a command to initiate a product order included in a text-based chat message from the participant. The text-based chat session may include a message with data identifying a product ordered by the participant and the generated and transmitted task data may include one or more messages generated based at least in part on the identified activity command and data identifying the ordered item.

In a further embodiment of the method 200 identifying the entity based on data included in a text-based message of the text-based chat session. In one such embodiment, the entity is a restaurant and the product order is an order of at least one menu item from the restaurant. Also, the generated and transmitted task data from the executing 204 is an order of at least one menu item based on the activity command. In some such embodiments, the generated and transmitted task data includes an order of a plurality of menu items based on a plurality of activity commands received over the network from a plurality of participants within the text-based chat session.

Some other embodiments further include receiving a reply to transmitting the task data. The reply in some such embodiments includes at least one of an acknowledgement of the order, an estimated time the order will be ready for pickup or delivered, a location where the order can be picked up or will be delivered, an amount due at a time of pickup or delivery, and at least one amount charged to at least one payment account. Other embodiments may include other data items, two or more of these or other data items, and the like.

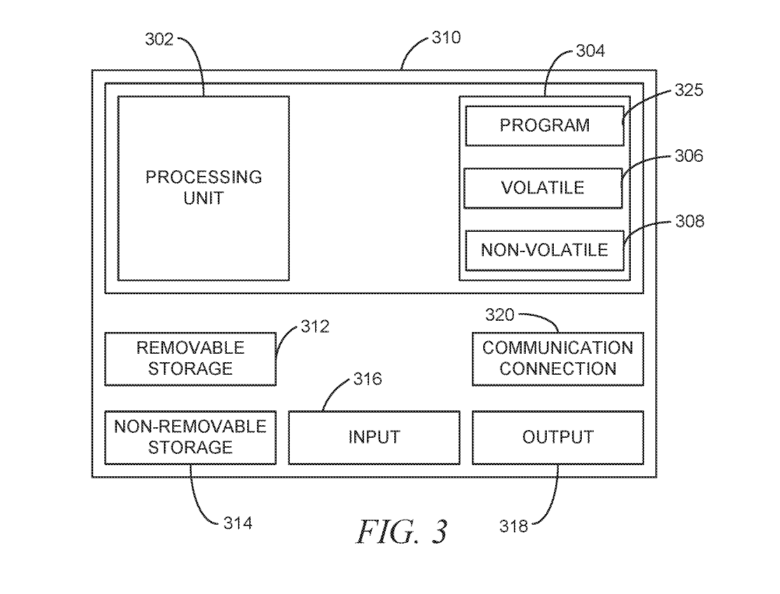

FIG. 3 is a block diagram of a computing device, according to an example embodiment. In one embodiment, multiple such computer systems are utilized in a distributed network to implement multiple components in a transaction-based environment. An object-oriented, service-oriented, or other architecture may be used to implement such functions and communicate between the multiple systems and components. One example computing device in the form of a computer 310, may include a processing unit 302, memory 304, removable storage 312, and non--removable storage 314. Memory 304 may include volatile memory 306 and non-volatile memory 308. Computer 310 may include or have access to a computing environment that includes a variety of computer-readable media, such as volatile memory 306 and non-volatile memory 308, removable storage 312 and non-removable storage 314. Computer storage includes random access memory (RAM), read-only memory (ROM), erasable programmable read-only memory (EPROM) & electrically erasable programmable read-only memory (EEPROM), flash memory or other memory technologies, compact disc read-only memory (CD-ROM), Digital Versatile Disks (DVD) or other optical disk storage, magnetic cassettes, magnetic tape, magnetic disk storage or other magnetic storage devices, or any other medium capable of storing computer-readable instructions. Computer 310 may include or have access to a computing environment that includes input 316, output 318, and a communication connection 320. The computer may operate in a networked environment using a communication connection to connect to one or more remote computers, such as database servers. The remote computer may include a personal computer (PC), server, router, network PC, a peer device or other common network node, or the like. The communication connection may include a Local Area Network (LAN), a Wide Area Network WAN) or other networks.

Computer-readable instructions stored on a computer-readable medium are executable by the processing unit 302 of the computer 310. A hard drive, CD-ROM, and RAM are some examples of articles including a non-transitory computer-readable medium. For example, a computer program 325 capable of performing one or more of the methods or providing one or more functions illustrated and described herein.

It will be readily understood to those skilled in the art that various other changes in the details, material, and arrangements of the parts and method stages which have been described and illustrated in order to explain the nature of the inventive subject matter may be made without departing from the principles and scope of the inventive subject matter as expressed in the subjoined claims.

What is claimed is:

1. A method comprising:
identifying an activity mand received over a network from a participant within a text-based chat session.; and
executing a data processing activity associated with the identified activity command, the executing of the activity including generating and transmitting task data over the network to a data processing system of an entity that will perform a task based on the task data.

2. The method of claim 1, wherein the activity command is a command to tia a product order included in a text-based chat message from the participant.

3. The method of claim 2, wherein the text-based chat session includes a message with data identifying a product ordered by the participant.

4. The method of claim 3, wherein the generated and transmitted task data includes at least one message generated based at least in part on the identified activity command and data identifying the ordered item.

5. The method of claim 1, further comprising:
identifying the entity based on data included in a text-based message of the text-based chat session.

6. The method of claim 5. wherein:
the entity is a restaurant;
the product order is an order of at least one menu iten)rn the restaurant; and
the generated and transmitted task data is an order of at least one menu item based on the activity cpmmand.

7. The method of claim 6, wherein the generated and transmitted task data includes an order of a plurality of menu items based on a plurality of activity commands received over the network from a plurality of participants within the text-based chat session.

8. The method of claim 6, further comprising:
receiving a reply to transmitting the task data, the reply including at least one of an acknowledgement of the order, an estimated time the order will be ready for pickup or delivered, a location where the order can be picked up or will be delivered, an amount due at a time of pickup or delivery, and at least one amount charged to at least one payment account.

9. The method of claim 8, wherein the method is performed at least in part by a software component that participates within the text-based chat session.

10. A method comprising:
identifying activity commands received over a network from a plurality of participants within a text-based chat session; and
executing data processing activities associated with the identified activity commands, the executing of the activities including generating and transmitting task data over the network to a data processing system of an entity that will perform tasks based on the task data.

11. The method of claim 10, wherein:
the activity command is a command to initiate a product order included in a text-based chat message from the participant;
the text-based chat session includes a message ith data identifying a product ordered by the participant; and
the generated and transmitted task data includes at least one message generated based at least in part on the identified activity command and data identifying the ordered item.

12. The method of claim 11, further comprising:
identifying the entity based on data included in a to sed message of the text-based chat session.

13. The method of claim 12, wherein:
the entity is a restaurant;
the product order is an order of at least one menu item from the restaurant; and
the generated and transmitted task data includes an order of a plurality of menu items based on a plurality of activity commands received over the network from a plurality of participants within the text-based chat session.

14. The method of claim 13, further comprising:
receiving a reply to transmitting the task data, the reply including two or more of an acknowledgement of the order, an estimated time the order will be ready for pickup or delivered, a location where the order can be picked up or will be delivered, an amount due at a time of pickup or delivery, and at least one amount charged to at least one payment account.

15. The method of claim 10, wherein the method is performed at least in part by a software component that participates within the text-based chat session.

16. A system comprising:
a network interface device;
a computer processor;
a memory device storing instruction s thatare executable by the iputer processor to perform data processing activities comprising:
identifying an activity command received via the network interface device from a participant within a text-based chat session; and
executing a data processing activity associated with the identified activity command, the executing of the activity including generating and transmitting task data via the network interface device to a data processing system of an entity that will perform a task based on the task data.

17. The system of claim 16, wherein:
the activity command is a command to initiate a product order included in a text-based chat message from the participant;
the text-based chat session includes a message with identifying a. product ordered by the participant; and
the generated and transmitted task data includes at least one message generated based at least in part on the identified activity command and data identifying the ordered item.

18. The system claim 17, wherein the data processing activities further comprise:
identifying the entity based on data included in a text-based message of the text-based chat session.

19. The system of claim 18, wherein:
the entity is a restaurant;
the product order is an order of at least one menu item from the restaurant; and
the generated and transmitted task data is an order of at east one menu item based on the activity command.

20. The system of claim 19, wherein the generated and transmitted task data includes an order of a plurality of menu items based on a plurality of activity commands received via the network interface device from a plurality of participants within the text-based chat session.
